(19) United States
(12) Patent Application Publication
(10) Pub. No.: US 2004/0078762 A1
(43) Pub. Date: Apr. 22, 2004

(54) Multi-lingual information server apparatus and method for operation thereof

(75) Inventors: Chia San Lee, Hsinchu (TW); Ching Chuan Hsieh, Hsinchu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/272,654

(22) Filed: Oct. 17, 2002

(51) Int. Cl. G06F 15/00

(52) U.S. Cl. 715/536; 709/219

(57) ABSTRACT

A distributed communications network apparatus and method employ a plurality of static information pages in a plurality of languages. The apparatus and method also employ a language selection utility for purposes of selecting a static page within the plurality of static pages, in accord with a language preference determined with respect to a requester. The requester may then be directed to the static page within the plurality of static pages, in accord with the language preference. By employing the plurality of static pages in conjunction with the language selection utility, the apparatus and method are provided with enhanced efficiency.

### BACKGROUND OF THE INVENTION

1. Field of the Invention

The present invention relates generally to information server apparatus and associated methods for operation thereof. More particularly, the present invention relates to multi-lingual information server apparatus with enhanced performance, and associated methods for operation thereof.

2. Description of the Related Art

The use of the Internet and the World Wide Web (WWW) as a communications and information distribution infrastructure has received considerable attention and acceptance. Internet and World Wide Web communications routinely traverse international boundaries for the purposes of information distribution.

While the global character of Internet and World Wide Web communications and information distribution has presumably assisted in their considerable growth, such global character is nonetheless not entirely without problems.

In that regard, it is often difficult with the Internet and World Wide Web communications and information distribution infrastructure to efficiently provide multi-lingual capabilities for communications and information distribution.

It is towards the foregoing object that the present invention is directed.

Various Internet and World Wide Web related apparatus, systems and methods having desirable properties have been disclosed within the communications and information distribution arts.

Included but not limited among the apparatus, systems and methods are apparatus, systems and methods disclosed within: (1) Nazem et al., in U.S. Pat. No. 5,983,227 (a Web page server apparatus for use within Internet and World Wide Web distributed communications networks); and (2) Cuomo et al., in U.S. Pat. No. 6,286,043 (a system, computer program and method for use when fabricating dynamic Web pages for distribution within Internet and World Wide Web distributed communications networks).

The teachings of each of the foregoing references is incorporated herein fully by reference.

Desirable are additional apparatus and methods which efficiently provide multi-lingual capabilities for Internet and World Wide Web communications and information distribution.

It is towards the foregoing object that the present invention is directed.

### SUMMARY OF THE INVENTION

A first object of the invention is to provide an Internet and World Wide Web communications and information distribution apparatus and method.

A second object of the invention is to provide an apparatus and method in accord with the first object of the invention, wherein the apparatus and method efficiently provide multi-lingual capabilities for communications and information distribution.

In accord with the objects of the invention, the invention provides a server apparatus and a method for operation of the server apparatus.

In accord with the invention, the server apparatus comprises a distributed communications network information server capable of providing information in a page format in a plurality of languages. The server apparatus also comprises a plurality of static information pages associated with the server, where the plurality of static information pages is provided in the plurality of languages. Finally, the server apparatus also comprises a language selection utility associated with the server, where the language selection utility is able to determine from a requester a language preference for a page of information such that the server may direct the requester to a requested information static page from the plurality of static information pages, in accord with the language preference.

The server apparatus in accord with the present invention contemplates a method for operation of the server apparatus in accord with the present invention.

The present invention provides an Internet and World Wide Web communications and information distribution apparatus and method, wherein the apparatus and method efficiently provide multilingual capabilities for communications and information distribution.

The present invention realizes the foregoing objects within the context of a distributed communications network information server (such as but not limited to an Internet and World Wide Web distributed communications network information server) capable of providing information in a page format in a plurality of languages. Within the invention, the distributed communications network information server has associated therewith: (1) a plurality of static information pages provided in the plurality of languages; and (2) a language selection utility which is able to determine from a requester a language preference for a page of information such that the server apparatus may direct the requester to a requested information static page from the plurality of static information pages, in accord with the language preference.

### BRIEF DESCRIPTION OF THE DRAWINGS

The objects, features and advantages of the invention are understood within the context of the Description of the Preferred Embodiment, as set forth below. The Description of the Preferred Embodiment is understood within the context of the accompanying drawings, which form a material part of this disclosure, wherein:

FIG. 1 shows a schematic block diagram of a distributed communications network system having incorporated therein a multilingual information server apparatus in accord with the present invention.

FIG. 2 shows a schematic process flow diagram of operation of the distributed communications network system in accord with the present invention.

### DESCRIPTION OF THE PREFERRED EMBODIMENT

The present invention provides an Internet and World Wide Web communications and information distribution apparatus and method, wherein the apparatus and method efficiently provide multilingual capabilities for communications and information distribution.

The present invention realizes the foregoing objects within the context of a distributed communications network information server (such as but not limited to an Internet and World Wide Web distributed communications network information server) capable of providing information in a page format in a plurality of languages. Within the invention, the distributed communications network information server has associated therewith: (1) a plurality of static information pages provided in the plurality of languages; and (2) a language selection utility which is able to determine from a requester a language preference for a page of information such that the server apparatus may direct the requester to a requested information static page from the plurality of static information pages, in accord with the language preference.

While the preferred embodiment of the invention provides particular value within the context of providing enhanced multilingual capabilities for communications and information distribution within an Internet and World Wide Web distributed communications network, the invention is not intended to be so limited. Rather the invention may be employed for providing enhanced multi-lingual capabilities for communications and information distribution within distributed communications networks including but not limited to Internet and World Wide Web distributed communications networks, intranet distributed communications networks, wide area distributed communications networks and local area distributed communications networks. Within the invention, distributed communications networks are intended as multi-access communications networks where multiple requester parties may simultaneously issue communications or information requests from multiple server entities, which are generally computer server entities.

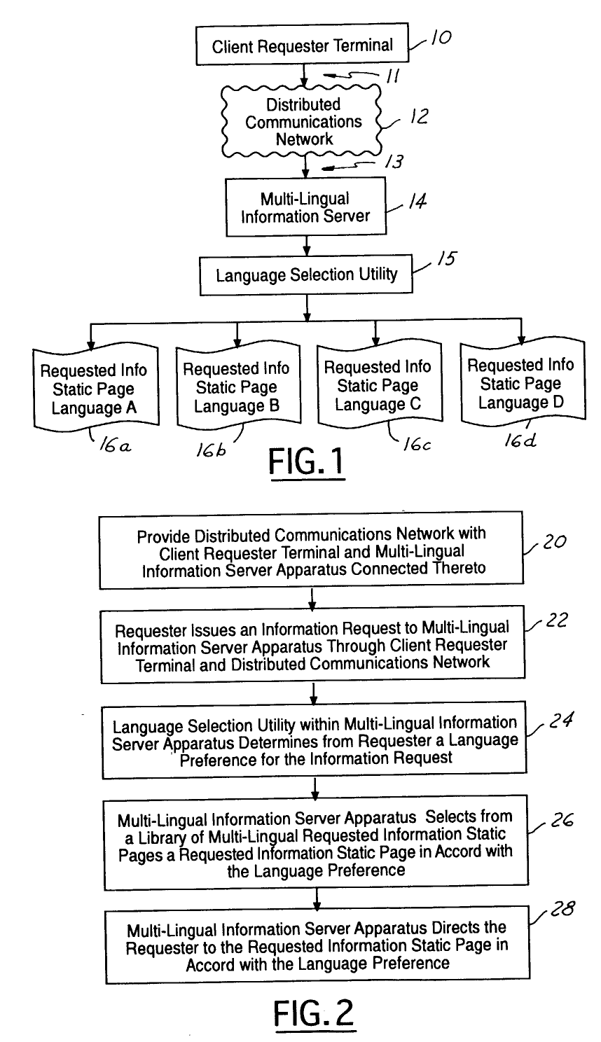

FIG. 1 shows a schematic block diagram of a distributed communications network system having incorporated therein a multilingual information server apparatus in accord with the present invention.

FIG. 1 shows a client requester terminal 10 which is connected to a distributed communications network 12 through a client requester communications link 11. Also connected to the distributed communications network 12 is a multi-lingual information server 14 which is connected through a multi-lingual information server communications link 13.

Within the invention, a requester (which is not otherwise specifically illustrated) may employ the client requester terminal 10 for purposes of accessing information from an entity (such as but not limited to a governmental, educational, military, organizational or commercial entity) which is associated with and maintains the multi-lingual information server 14. The client requester terminal 10 may be otherwise generally conventional in the communications and information distribution art. Typically, but not exclusively, the client requester terminal 10 will be a computer terminal which operates a distributed communications network software product appropriate for communication and information distribution through the distributed communications network 12. Under circumstances where the distributed communications network 12 is an Internet and World Wide Web distributed communications network, the distributed communications network software product will typically comprise an Internet and World Wide Web communication and information distribution software product.

Within the invention, and in accord with disclosure above, the distributed communications network 12 may be selected from the group including but not limited to Internet and World Wide Web distributed communications networks, intranet distributed communications networks, wide area network distributed communications networks and local area network distributed communications networks. Within the preferred embodiment of the invention, the distributed communications network 12 is typically an Internet and World Wide Web distributed communications network.

Within the invention, the multi-lingual information server 14 may be provided as any of several servers as are conventional or unconventional within the communications and information distribution art, including but not limited to personal computer servers, mini-computer servers, mid-range computer servers and main-frame computer servers. Typically, the multi-lingual information server 14 will be sized appropriately to the nature of the entity which maintains it, and to a volume of information requests that requesters forward to it.

Within the invention, the client requester terminal communications link 11 and the multi-lingual information server communications link 13 may be provided employing components as are conventional within the communications and information distribution art. Such components may include hardware components and software components, as well as hard wired components and wireless components.

FIG. 1 also illustrates a series of requested information static pages 16a, 16b, 16c and 16d associated with the multilingual information server 14, as well as a language selection utility 15 also associated with the multi-lingual information server 14. Within the invention, the multi-lingual information server 14, the language selection utility 15 and the series of requested information static pages 16a, 16b, 16c and 16d in an aggregate provide a multi-lingual information server apparatus in accord with the invention.

Within the invention, the series of requested information static pages 16a, 16b, 16c and 16d is provided in a series of separate corresponding languages A, B, C and D, such as but not limited to English, Chinese, Japanese, Korean, French, Italian and German. Although not specifically illustrated in FIG. 1, the series of requested information static pages 16a, 16b, 16c and 16d may otherwise be routinely updated and refreshed by the multi-lingual information server 14. However, each of the series of requested information static pages 16a, 16b, 16c and 16d is complete and static in its content. Each of the requested information static pages 16a, 16b, 16c and 16d requires no additional content and is not dynamically generated or updated incident to having directed thereto a requester.

Within the invention, the language selection utility 15 is intended to determine from an information request forwarded from the client requester terminal 10 a preference for a requested information static page in a specific language. Mechanisms for such determination are disclosed further below, within the context of discussion of the schematic process flow diagram of FIG. 2.

FIG. 2 shows a schematic process flow diagram of operation of the distributed communications network system in accord with the present invention.

As is illustrated in FIG. 2, and in accord with the block which corresponds with reference numeral 20, there is first provided within the invention a distributed communications network having connected thereto a client requester terminal and a multilingual server apparatus.

Within the invention, the client requester terminal corresponds within the client requester terminal 10 as illustrated within the schematic block diagram of FIG. 1, the distributed communications network corresponds with the distributed communications network 12 as illustrated within the schematic block diagram of FIG. 1 and the multi-lingual server apparatus corresponds with the multi-lingual information server 14, the language selection utility 15 and the series of requested information static pages 16a, 16b, 16c and 16d as illustrated within the schematic block diagram of FIG. 1.

As is also illustrated within FIG. 2, and in accord with the block which corresponds with reference numeral 22, a requester issues an information request to the multi-lingual information server apparatus through the client requester terminal and the distributed communications network.

Within the invention, the client's information request may be issued employing any of several means as are conventional in the communications and information distribution art, including in particular issuance of an information request while employing keyboard and graphical user interface browsing methods.

As is also illustrated in FIG. 2, and in accord with the block which corresponds with reference numeral 24, the language selection utility within the multi-lingual information server apparatus determines from the requester a language preference for the information request.

Within the invention under circumstances where the requester has not previously requested any information from the multi-lingual information server apparatus, the language selection utility (through the multi-lingual information server) may need to provide a direct request to the requester for a language preference. Under circumstances where the requester might previously have requested from the multi-lingual information server apparatus an initial information request along with an initial language preference, the initial language preference may be stored for future reference within either or both of the client requester terminal (i.e., as a client “cookie” on a hard disk) or within the multi-lingual information server apparatus (i.e., as a server “cookie” on a hard disk).

As is also illustrated within FIG. 2, and in accord with the block which corresponds with reference numeral 26, the multilingual information server apparatus selects from a library of multi-lingual requested information static pages a requested information static page in accord with the language preference.

Finally, as is also illustrated within FIG. 2, and in accord with the block which corresponds with reference numeral 28, the multi-lingual information server apparatus directs the requester to the requested information static page in accord with the language preference.

Within the invention, by employing the plurality of requested information static pages provided with the a plurality of language, the multi-lingual information server apparatus may operate more efficiently (i.e., with enhanced speed) in comparison with requested information pages otherwise dynamically generated. Thus, the present invention provides a multi-lingual information server apparatus and method with enhanced efficiency.

As is understood by a person skilled in the art, the preferred embodiment of the invention is illustrative of the invention rather than limiting of the invention. Revisions and modifications may be made to apparatus, systems and methods in accord with the preferred embodiment of the invention while still providing an apparatus and method in accord with the invention, further in accord with the accompanying claims.

What is claimed is:

1. A server apparatus comprising:
a distributed communications network information server capable of providing information in a page format in a plurality of languages;
a plurality of static information pages associated with the server, the plurality of static information pages being provided in the plurality of languages; and
a language selection utility associated with the server, the language selection utility being able to determine from a requester a language preference for a page of information such that the server apparatus may direct the requester to a requested information static page from the plurality of static information pages, in accord with the language preference.

2. The server apparatus of claim 1 wherein the distributed communications network is an Internet and World Wide Web distributed communications network.

3. The server apparatus of claim 1 wherein the distributed communications network is selected from the group consisting of intranet, wide area network and local area network distributed communications networks.

4. The server apparatus of claim 1 wherein the plurality of languages comprises at minimum English and Chinese.

5. The server apparatus of claim 1 wherein the language selection utility detects the language preference within a cookie within a hard disk within a client requester terminal.

6. A method for operating a distributed communications network comprising:
providing a distributed communications network having connected thereto a client requester terminal and a multi-lingual information server apparatus, the multi-lingual information server apparatus comprising:
a distributed communications network information server capable of providing information in a page format in a plurality of languages;
a plurality of static information pages associated with the server, the plurality of static information pages being provided in the plurality of languages; and
a language selection utility associated with the server, the language selection utility being able to determine from a requester a language preference for a page of information such that the server apparatus may direct the requester to a requested information static page from the plurality of static pages, in accord with the language preference;
issuing by a requester, and through the client requester terminal, an information request to the multi-lingual information server apparatus with a detectable language preference; and
directing the requester to a static information page in accord with the language preference while employing the language selection utility.

7. The method of claim 6 wherein the distributed communications network is an Internet and World Wide Web distributed communications network.

8. The method of claim 6 wherein the distributed communications network is selected from the group consisting of intranet, wide area network and local area network distributed communications networks.

9. The method of claim 6 wherein the plurality of languages comprises at minimum English and Chinese.

10. The method of claim 6 wherein the language selection utility detects the language preference within a cookie within a hard drive within the client requester terminal.
